(19) United States
(12) Patent Application Publication
(10) Pub. No.: US 2022/0065792 A1
(43) Pub. Date: Mar. 3, 2022

(54) A SYSTEM AND A METHOD OF PERFORMING SPECTROSCOPIC ANALYSIS OF A SAMPLE

(71) Applicant: National University of Singapore, Singapore (SG)

(72) Inventors: Minghui HONG, Singapore (SG); Yang LI, Singapore (SG)

(21) Appl. No.: 17/420,352

(22) PCT Filed: Feb. 13, 2020
(86) PCT No.: PCT/SG2020/050072

§ 371 Date: Jul. 1, 2021

(30) Foreign Application Priority Data
Feb. 15, 2019 (SG) 10201901315X

(51) Int. Cl. G01N 21/65; G02B 3/00; G02B 27/14; G02B 27/10

(52) U.S. Cl. CPC G01N 21/658; G02B 3/0037; G01N 2201/0633; G02B 27/1013; G02B 27/141

(57) ABSTRACT

A system for performing spectroscopic analysis of a sample, and a method of performing spectroscopic analysis of a sample are provided, the system comprising, an array of lenses positioned adjacent to a surface of the sample such that incident electromagnetic radiation passes through the array of lenses before irradiating the surface of the sample, and wherein the array of lenses is further configured to direct the incident electromagnetic radiation passing therethrough to form a plurality of incident electromagnetic radiation, each of the plurality of incident electromagnetic radiation irradiating a different focused spot on the surface of the sample.

### TECHNICAL FIELD

The present disclosure relates broadly to a system and a method of performing spectroscopic analysis of a sample.

### BACKGROUND

Raman spectroscopy is a useful technique for observing vibrational, rotational and other low-frequency modes in a molecule. Raman spectroscopy relies on inelastic scattering of photons, known as Raman scattering. Typically, a source of excitation light e.g. monochromatic laser light is used to illuminate a sample, thereby interacting with vibrations, rotations and other low-frequency modes in a molecule. Elastic scattered radiation at the wavelength corresponding to the laser light (i.e. Rayleigh scattering) is filtered while the rest of the scattered radiation is collected to obtain a spectrum. In general, the vibrations or rotations of chemical bonds are different for different types of molecules. As such, a Raman spectroscope may provide a fingerprint by which molecules can be identified.

However, Raman scattering signals tend to be weak as compared to Rayleigh scattering. On one hand, weak Raman scattering signals make it difficult to separate Raman scattered light from reflected excitation light. Typically, a notch filter, an edge pass filter or a band pass filter are used to filter out the reflected excitation light, before the Raman scattering light can be detected. On the other hand, the power of Raman scattering signal is so low that the signal to noise ratio (SNR) in detection is low as well.

One way of increasing the intensity of Raman scattering signals is to increase the power of the laser used to illuminate the sample. However, if the laser power is too high, some samples may be damaged. Even worse, if the sample is flammable, the sample may be destroyed by the increased laser power.

For a bench-top/table-top Raman system, the issue of weak Raman scattering signals may not pose a significant challenge as a Raman spectrometer with a relatively high sensitivity and relatively low background noise detector is typically employed. However, the issue of weak Raman scattering becomes exacerbated in portable Raman spectrometers. For such portable devices, a detector with limited size and space is typically employed, thereby leading to relatively low sensitivity and high noise. While this type of spectrometer may be sensitive enough for detection of transmitted/reflective spectra and fluorescent signals, the noise of these spectrometers may be as high as the Raman signal if the input power is low, thus resulting in a low SNR. For these spectrometers, it may not be feasible to increase the Raman signal via increasing the laser power.

Thus, there is a need for a system and a method of performing spectroscopic analysis of a sample, which seeks to address or at least ameliorate one or more of the above problems.

### SUMMARY

In one aspect, there is provided a system for performing spectroscopic analysis of a sample, the system comprising, an array of lenses positioned adjacent to a surface of the sample such that incident electromagnetic radiation passes through the array of lenses before irradiating the surface of the sample, and wherein the array of lenses is further configured to direct the incident electromagnetic radiation passing therethrough to form a plurality of incident electromagnetic radiation, each of the plurality of incident electromagnetic radiation irradiating a different focused spot on the surface of the sample.

In one embodiment of the system disclosed herein, the array of lenses comprises a plurality of lenses disposed on a support layer, and wherein the support layer is a substantially rigid layer, or a substantially flexible layer that is configured to substantially conform to the surface of the sample.

In one embodiment of the system disclosed herein, the array of lenses is configured to contact the surface of the sample; or is configured to be positioned no more than 1000 μm from the surface of the sample.

In one embodiment of the system disclosed herein, the array of lenses comprises a focal plane such that the surface of the sample is arranged to be substantially parallel to the focal plane.

In one embodiment of the system disclosed herein, the system further comprises a monochromatic electromagnetic wave emitter configured to emit the incident electromagnetic radiation, wherein the incident electromagnetic radiation has a frequency selected from the ultraviolet, visible, or infrared spectrum.

In one embodiment of the system disclosed herein, the array of lenses is further configured to direct a scattered electromagnetic radiation from the sample to a detector unit of a spectrometer, said scattered electromagnetic radiation comprising radiation reflected or scattered from the sample.

In one embodiment of the system disclosed herein, the scattered electromagnetic radiation comprises Raman signals, said Raman signals having a higher or lower frequency as compared to the frequency of the incident electromagnetic radiation.

In one embodiment of the system disclosed herein, the system further comprises an optical assembly configured to direct the incident electromagnetic radiation from the emitter towards the array of lenses, the optical assembly further configured to direct the scattered electromagnetic radiation from the array of lenses to the detector unit of the spectrometer.

In one embodiment of the system disclosed herein, the optical assembly comprises, a splitter configured to receive and reflect the incident electromagnetic radiation from the emitter towards the array of lenses, said splitter further configured to reflect the scattered electromagnetic radiation from the array of lenses to the detector unit of the spectrometer; a filter configured to reject electromagnetic waves from the scattered electromagnetic radiation that has substantially the same frequency as the incident electromagnetic radiation; and a focusing lens configured to direct the scattered electromagnetic radiation to the detector unit of the spectrometer.

In one aspect, there is provided a method of performing spectroscopic analysis of a sample, the method comprising, positioning an array of lenses adjacent to a surface of the sample such that incident electromagnetic radiation passes through the array of lenses before irradiating the surface of the sample, directing the incident electromagnetic radiation passing through the array of lenses to form a plurality of incident electromagnetic radiation such that each of the plurality of incident electromagnetic radiation irradiates a different focused spot on the surface of the sample.

In one embodiment of the method disclosed herein, the array of lenses comprises a plurality of lenses disposed on a support layer, and wherein the support layer is a substantially rigid layer, or a substantially flexible layer configured to substantially conform to the surface of the sample.

In one embodiment of the method disclosed herein, positioning the array of lenses adjacent to the surface of the sample comprises contacting the array of lenses to the surface of the sample, or positioning the array of lenses at no more than 1000 μm from the surface of the sample.

In one embodiment of the method disclosed herein, the method further comprises positioning the array of lenses such that the surface of the sample is substantially parallel to a focal plane of the array of lenses.

In one embodiment of the method disclosed herein, the method further comprises emitting the incident electromagnetic radiation from a monochromatic electromagnetic wave emitter, wherein the incident electromagnetic radiation has a frequency selected from the ultraviolet, visible, or infrared spectrum.

In one embodiment of the method disclosed herein, the method further comprises directing a scattered electromagnetic radiation passing through the array of lenses to a detector unit of a spectrometer, wherein the scattered electromagnetic radiation comprises radiation reflected or scattered from the sample.

In one embodiment of the method disclosed herein, the scattered electromagnetic radiation comprises Raman signals having a higher or lower frequency as compared to the frequency of the incident electromagnetic radiation.

In one embodiment of the method disclosed herein, the method further comprises providing an optical assembly to direct the incident electromagnetic radiation from the emitter towards the array of lenses, and to direct the scattered electromagnetic radiation from the array of lenses to the detector unit of the spectrometer.

In one embodiment of the method disclosed herein, the method further comprises, receiving and reflecting the incident electromagnetic radiation from the emitter towards the array of lenses; reflecting the scattered electromagnetic wave radiation from the array of lenses to the detector unit; filtering the scattered electromagnetic wave radiation to reject electromagnetic waves from the scattered electromagnetic wave radiation that has substantially the same wavelength as the incident electromagnetic wave radiation; and focusing the filtered scattered electromagnetic radiation into the detector unit of the spectrometer.

In one aspect, there is provided an attachment for a system for performing spectroscopic analysis of a sample, the attachment comprising, an array of lenses configured to be positioned adjacent to a surface of the sample such that incident electromagnetic radiation for irradiating the surface of the sample passes through the array of lenses before irradiating the surface of the sample, and wherein the array of lenses is further configured to direct the incident electromagnetic radiation passing therethrough to form a plurality of incident electromagnetic radiation, each of the plurality of incident electromagnetic radiation irradiating a difference focused spot on the surface of the sample.

In one embodiment of the attachment disclosed herein, the array of lenses comprises a plurality of lenses disposed on a support layer, and wherein the support layer is a substantially rigid layer, or a substantially flexible layer that is configured to substantially conform to a surface of the sample.

### BRIEF DESCRIPTION OF THE DRAWINGS

Example embodiments of the invention will be better understood and readily apparent to one of ordinary skill in the art from the following written description, by way of example only, and in conjunction with the drawings, in which:

FIG. 1 is a schematic diagram of a system for performing spectroscopic analysis on a sample in an example embodiment.

FIG. 2A is a perspective view drawing of a system for performing spectroscopic analysis of a sample in an example embodiment.

FIG. 2B is a side view drawing of the system in the example embodiment.

FIG. 3 is a photograph showing a system for performing spectroscopic analysis on a sample in an example embodiment.

FIG. 4 is a graph comparing a first Raman spectra measured by the micro-lens array (MLA) setup of FIG. 3 and a second Raman spectra measured by a traditional single lens setup.

FIG. 5A is a perspective view drawing of a system for performing spectroscopic analysis of a sample in an example embodiment.

FIG. 5B is a side view drawing of the system in the example embodiment.

FIG. 5C is a magnified view of the MLA in the example embodiment.

FIG. 6A is a photograph showing microspheres distributed on a poly(ε-caprolactone) (PCL) film in an example embodiment.

FIG. 6B is a photograph showing microspheres distributed on a SERS (surface-enhanced Raman scattering) substrate in an example embodiment.

FIG. 7 is a graph comparing a first Raman spectra detected by the MLA setup of FIG. 5 and a second Raman spectra detected by a conventional lens setup.

FIG. 8 is a schematic flowchart for illustrating a method of performing spectroscopic analysis of a sample in an example embodiment.

FIG. 9 is a schematic drawing of a computer system suitable for implementing the described example embodiments.

### DETAILED DESCRIPTION

Example, non-limiting embodiments may provide a system for performing spectroscopic analysis of a sample and a method of performing spectroscopic analysis of a sample.

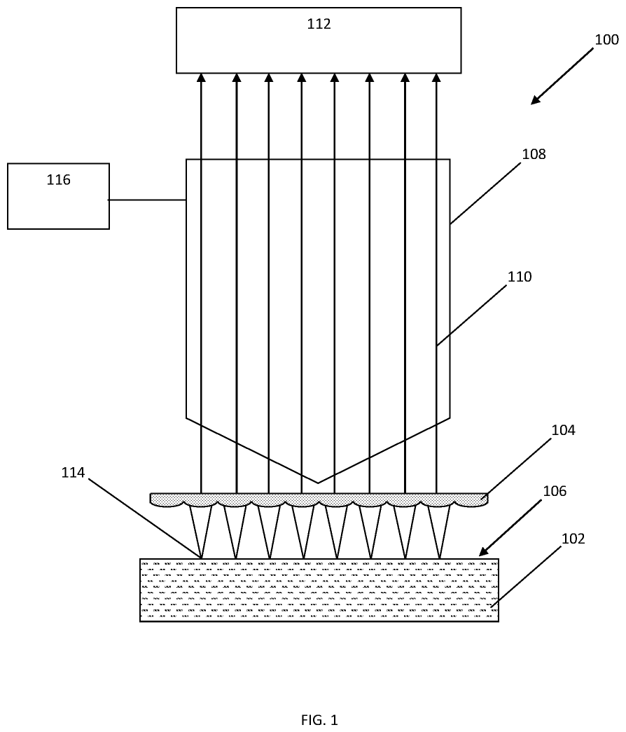

FIG. 1 is a schematic diagram of a system 100 for performing spectroscopic analysis on a sample 102 in an example embodiment. The system 100 comprises an array of lenses e.g. micro-lens array (MLA) 104 positioned adjacent to a surface 106 of the sample 102 such that a first incident electromagnetic radiation 108 for irradiating the surface 106 of the sample 102 passes through the MLA 104 before irradiating the surface 106 of the sample 102. The MLA 104 is further configured to direct the first incident electromagnetic radiation 108 passing therethrough to form a plurality of incident electromagnetic radiation e.g. focused spot array. Each of the plurality of incident electromagnetic radiation irradiates a different focused spot/focal spot e.g. 114 on the surface 106 of the sample 102. The MLA 104 may be further configured to direct a second scattered electromagnetic radiation 110 away from the surface 106 of the sample 102 towards a detector unit 112 of a spectrometer.

The first incident electromagnetic radiation 108 comprises an electromagnetic wave e.g. excitation light or excitation laser beam capable of exciting a target region of the sample 102. The first incident electromagnetic radiation 108 may be emitted from a source e.g. electromagnetic wave emitter 116. The second scattered electromagnetic radiation 110 comprises electromagnetic waves that are scattered e.g. backscattered, emitted and/or reflected by the sample 102, e.g. Raman scattering signals and Rayleigh scattering signals. Backscatter (or backscattering) may be understood as the reflection of waves, particles, or signals back to the direction from which they came. Backscattering is defined also as the phenomenon that occurs when radiation or particles are scattered at angles to the original direction of motion of greater than 90 degrees e.g. about 180 degrees, or between 90 and 180 degrees. In alternative example embodiments, the second scattered electromagnetic radiation may comprise electromagnetic waves that are transmitted through the sample. That is, the first incident electromagnetic radiation e.g. excitation laser may irradiate a first side of the sample surface and the second electromagnetic radiation containing Raman signal may be collected from a second opposite side of the sample surface.

In the example embodiment, the MLA 104 is configured to direct the first incident electromagnetic radiation 108 passing therethrough to form a plurality of focused spots e.g. 114 or focused spot array on the surface 106 of the sample 102. Each focused spot 114 of the plurality of focused spots defines a different area on the sample illuminated by the incident electromagnetic radiation 108 which has been split by the MLA 104. That is, each of the incident light passes through the MLA and splits into a plurality of rays of light, with each lens of the MLA serving to focus one incident ray of light on a particular/different spot on the sample, such that the spots do not overlap each other. This can allow for the overall power of the incident light to be increased, while ensuring that each of the plurality of each split incident ray of light to remain within a desired power threshold. The first incident electromagnetic radiation 108 may have a cross sectional diameter ranging from about 1 mm to about 100 mm. After the incident electromagnetic radiation 108 passes through the MLA 104, each of the plurality of focused spots 114 may have a cross sectional diameter ranging from about 1 μm to about 100 μm.

The MLA 104 may be used to excite multiple spots at the surface 106 of the sample 102 for Raman signal generation. The MLA 104 may also be used to collect the Raman signal generated from the sample 102. The focused spots array may advantageously provide for strong Raman signal collection by increasing the signal to noise ratio. By using the MLA 104, a single focused spot can be split into a plurality of focused spots e.g. 114, which can reduce the power intensity on the sample surface 106 and increase the number of the Raman signal sources from the sample surface 106 to increase the total intensity of the Raman signal.

It will be appreciated that when samples are irradiated or excited by an excitation laser, the power of the excitation laser must not exceed certain thresholds. Otherwise, the sample may be irreversibly damaged. For example, for a sample with a relatively low threshold for withstanding damage by an excitation laser, the maximum intensity of a focused spot for Raman signal detection may be fixed as a constant. For a single lens, the maximum incident power is taken to be P₀. If an incident beam of electromagnetic radiation 108 is illuminated on an MLA 104 comprising of n number of lenses, the total incident power can be increased to nP₀. This is because each lens within the micro-lens focuses the incident electromagnetic radiation on a different focused spot on the sample. Therefore, advantageously, the total power of the Raman signal can be increased by n times without damaging the sample. The reflected or scattered Raman signal from the sample can then be collimated by the MLA 104 and collected by a spectrometer. Therefore, such a configuration advantageously provides multi-focus spots to increase the SNR in Raman signal detection by n times.

In the example embodiment, the MLA may also significantly simplify the design of a Raman spectrometer and increase its performance. For example, in a Raman detection system using a conventional focusing lens, the relatively large size of the focusing lens often requires a beam expander to modify the size of the excitation laser beam in order to match the size of the focusing lens. Otherwise, the excitation laser beam cannot be well focused. However, by using the MLA 104, the excitation laser beam can illuminate a part of the MLA as each lens in the MLA is capable of working independently. Therefore, the focusing efficiency of the MLA 104 may be significantly higher than a single lens without a beam expander. Such a configuration using the MLA 104 can result in significant space saving in the design of a portable Raman spectrometer.

Moreover, an input slit of a spectrometer typically has a width of about 20 μm, which is significantly bigger than the diffraction limit of the spectrometer. Therefore, the input slit may be capable of collecting more signals than a single point. For the conventional single lens design, only the area of the focusing point contributes to Raman signal detection, which makes the light intensity well concentrated. In the example embodiment, the MLA can fully utilize the width of the slit in the spectrometer. In addition, a series of spots array of Raman light can also be collected by the spectrometer.

In various example embodiments, the array of lenses is positioned adjacent to the surface of the sample. In this context, the term “adjacent” means near or against. That is, the array of lenses is positioned immediately before the sample such that the incident electromagnetic radiation passes through the array of lenses immediately prior to irradiating the surface of the sample. It would be appreciated that the array of lenses is positioned nearer to the surface of the sample as compared to the source of the incident electromagnetic radiation or the detector unit of the spectrometer. For example, the array of lenses 104 may be positioned such that the array of lenses is in contact with the surface of the sample. For example, the array of lenses may be positioned at a distance from the surface of the sample that allows focusing of an excitation electromagnetic wave on the surface of the sample. It would be appreciated that the space between the array of lenses and the surface of the sample is relatively unobstructed so as to facilitate transmission of the incident electromagnetic radiation to the surface of the sample.

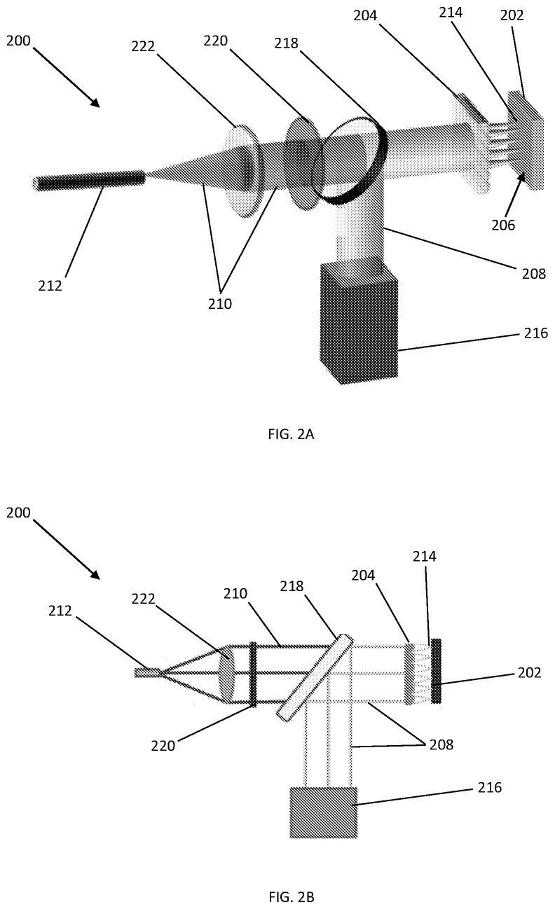

FIG. 2A is a perspective view drawing of a system 200 for performing spectroscopic analysis of a sample 202 in an example embodiment. FIG. 2B is a side view drawing of the system 200 in the example embodiment.

The system 200 comprises an array of lenses e.g. MLA 204 (compare 104 of FIG. 1) arranged to be positioned adjacent to a surface 206 of the sample 202. The MLA 204 may comprise a plurality of lenses e.g. high numerical aperture (NA) lenses disposed on a support layer. The support layer may be a substantially rigid layer, or a substantially flexible layer that is configured to substantially conform to the surface 206 of the sample 202. In the example embodiment, the support layer is a substantially rigid layer.

The MLA 204 comprises a focal plane such that the surface 206 of the sample 202 is arranged to be substantially parallel to the focal plane. The focal plane of the MLA 204 is also positioned to substantially align/coincide with the surface 206 of the sample 202. Depending on the working distance of the lens in the MLA 204, the MLA may be configured to contact the surface 206 of the sample 202 or may be configured to be positioned at a distance from the surface 206 of the sample 202. The MLA 204 may be configured to be positioned at a distance from about 1 μm to about 1000 μm, from about 5 μm to about 950 μm, from about 10 μm to about 900 μm, from about 20 μm to about 850 μm, from about 30 μm to about 800 μm, from about 40 μm to about 750 μm, from about 50 μm to about 700 μm, from about 60 μm to about 650 μm, from about 70 μm to about 600 μm, from about 80 μm to about 550 μm, from about 90 μm to about 500 μm, from about 100 μm to about 450 μm, from about 150 μm to about 400 μm, from about 200 μm to about 350 μm, or from about 250 μm to about 300 μm from the surface 206 of the sample 202.

The MLA 204 is configured to receive and direct electromagnetic radiation by allowing the electromagnetic radiation to pass through all or a portion of the plurality of lenses of the MLA 204. In the example embodiment, a first incident electromagnetic radiation 208 for irradiating the surface 206 of the sample 202 passes through the MLA 204 before irradiating the surface 206 of the sample 202. The MLA 204 is further configured to split the first incident electromagnetic radiation e.g. laser beam 208 passing therethrough into a plurality of incident electromagnetic radiation e.g. multiple split beams (spots), such that each of the split beam irradiates a different spot on the surface 206 of the sample 202.

The MLA 204 is further configured to direct a second scattered electromagnetic radiation 210 from the sample 202 to a detector unit e.g. through fibre 212 of a spectrometer. The scattered electromagnetic radiation 210 comprises radiation that is emitted, reflected and/or scattered from the sample 202. The scattered, emitted and/or reflected electromagnetic waves may comprise Raman signals having a higher or lower frequency as compared to the frequency of the first incident electromagnetic radiation. The MLA 204 is further configured to collimate the second scattered electromagnetic radiation 210, such that the collimated scattered electromagnetic radiation 210 can be substantially completely received by a detector unit 212 of the spectrometer.

The system 200 further comprises an electromagnetic wave emitter e.g. laser source 216 configured to generate/emit the first incident electromagnetic radiation e.g. excitation laser beam. The electromagnetic wave emitter may be a monochromatic electromagnetic wave emitter. The first incident electromagnetic radiation may have a wavelength from about 200 nm to about 1500 nm. The first incident electromagnetic radiation may be selected from the ultraviolet, visible, or infrared spectrum. In the example embodiment, the first incident electromagnetic radiation emitted from the electromagnetic wave emitter has a wavelength from about 500 nm to about 800 nm. In the example embodiment, the first incident electromagnetic radiation emitted from the electromagnetic wave emitter is selected from the visible or near infrared spectrum.

The system 200 further comprises a splitter e.g. beam splitter 218 which is an optical device that splits a beam of light into two. The beam splitter 218 may comprise an aperture and a reflective surface. The beam splitter 218 is configured to allow a portion of an incident electromagnetic radiation e.g. light in the optical path to be transmitted through the aperture of the beam splitter 218 and to allow a portion of the incident electromagnetic radiation in the optical path to be reflected from the reflective surface of the beam splitter 218. In the example embodiment, the beam splitter 218 is positioned in a beam-splitting position such that the first incident electromagnetic radiation 208 is reflected by the reflective surface and turned e.g., 90 degrees towards the array of lenses 204 which is positioned adjacent to the surface 206 of the sample 202. The resultant second scattered electromagnetic radiation 210 from the sample 202 is collected and collimated by the MLA 204 and the beam splitter 218 is configured to allow this collimated back-scattered electromagnetic radiation 210 to pass through the beam splitter 218, towards the detector unit 212 of the spectrometer. In other embodiments, a dichroic mirror may be used to replace the beam splitter 218 to increase the energy efficiency. A dichroic mirror is a mirror with significantly different reflection or transmission properties at two different wavelengths.

The system 200 further comprises a filter e.g. band-stop notch filter 220. A band-stop notch filter is a filter that passes most frequencies unaltered, but significantly attenuates those in a specific range to relatively low levels. In the example embodiment, the band-stop notch filter 220 is positioned between the beam splitter 218 and the through fibre 212 of the spectrometer. The band-stop notch filter 220 is specifically configured to reject electromagnetic waves from the second scattered electromagnetic radiation that has substantially the same frequency as the first electromagnetic radiation i.e. Rayleigh scattering signals. In other embodiments, a long-pass edge filter may be used in place of the band-stop notch filter. A long-pass edge filter is designed to transmit wavelengths greater than the cut-on wavelength of the filter.

The system 200 further comprises a focusing lens 222. In the example embodiment, the focusing lens 222 is positioned between the band-stop notch filter 220 and the through fibre 212 of the spectrometer. The focusing lens is configured to direct the second electromagnetic radiation 210 into the detector unit 212 of the spectrometer.

In the example embodiment, the splitter e.g. beam splitter 218, filter e.g. band-stop notch filter 220, and the focusing lens 222 forms an optical assembly configured to direct the first incident electromagnetic radiation 208 from the electromagnetic wave emitter e.g. laser source 216 towards the array of lenses 204 and to direct the second scattered electromagnetic radiation 210 from the array of lenses 204 to the detector unit 212 of the spectrometer.

It will be appreciated that lens design such as the selection of parameters e.g. focal length to achieve focusing on a surface and collimation of scattered e.g. backscattered light are known in the art and it is within the purview of a person skilled in the art to design lenses with suitable parameters for the system. It will also be appreciated that while the exemplary embodiment discloses a specific type of beam-splitter and filter, other types of beam splitters and filters may be employed to achieve the desired beam splitting and filtering functions.

In operation, the laser source 216 generates an excitation light in the form of a laser beam with narrow bandwidth on the beam splitter 218. The excitation light is reflected by the beam splitter 218 to illuminate on the MLA 204. The sample 202 is placed at the focal plane of the MLA 204, which is also substantially parallel to the MLA 204. Consequently, as the laser beam passes through the MLA 204, multiple focal spots of the laser beam are focused on the sample 202. Thereafter, the excitation laser beam from the MLA 204 interacts with the sample and generates a reflected or back-scattered light from the surface 206 of the sample 202. A portion of the back-scattered light passes through the MLA 204 and are collimated by the MLA 204 and sent towards the beam splitter 218. At the beam splitter 218, the back-scattered light signal is allowed to pass through and the back-scattered light can be filtered out by a band-stop notch filter (or a long-pass edge filter). Finally, the filtered back-scattered light (comprising the Raman signal) is focused via the focusing lens 222 into the detector unit 212 of the spectrometer for signal analyses.

In the example embodiment, the system 200 is portable. By portable, it is meant, among other things, that the system 200 is capable of being transported relatively easily as compared to a benchtop/tabletop system. The system 200 may have an overall size and/or weight which allows it to be transported relatively easily. For example, the system 200 may have a total weight of not more than 1 kg and/or may occupy a space with dimensions of not more than 200 mm (length) by 100 mm (width) by 80 mm (height). For example, the system 200 may be incorporated into a hand-held device e.g. portable spectrometer or a hand-carry suitcase.

In addition, the system 200 may be suitable for use in both laboratory-based testing and on-site/out-field testing. The term “on-site” as used herein refers to performance of an activity at a site of particular concern. For example, the system 200 may be used to perform spectroscopic analysis at a site/location where a sample material is obtained/located such that there is no need to transport the sample material back to the laboratory to be tested using a benchtop spectroscopic system. It would be appreciated that during transportation of a sample to the laboratory for analysis, the sample may be subjected to changes such as contamination, degradation and the like. Therefore, the system 200 can be more convenient over benchtop/table setups for analysis and may provide faster on-site analysis without undesirable changes to the integrity of the sample material.

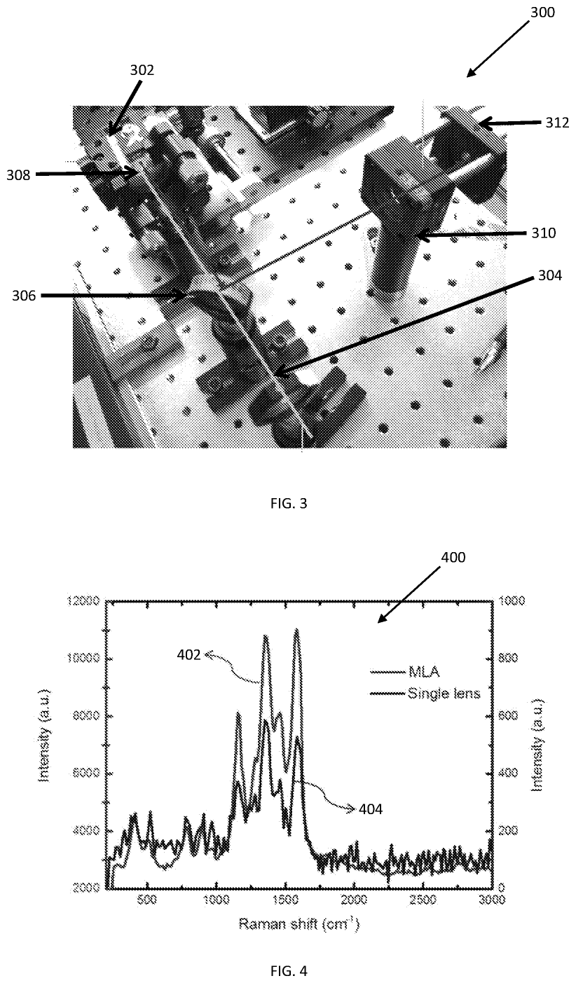

FIG. 3 is a photograph showing a system 300 for performing spectroscopic analysis on a sample 302 in an example embodiment. A 532 nm laser 304 illuminates the sample 302 through a beam splitter 306 and MLA 308. The reflected Raman signal is collimated by the MLA, reflected by the beam splitter 306, passing through a 532 nm band-stop notch filter 310 and focused into a fiber 312 leading to a spectrometer. The parallel and distance between the MLA and sample can be adjusted by a two-dimensional adjustable mount and a linear stage. The integration time for the spectrum detection is set as 10 seconds. The size of the laser beam is about 2 mm and the pitch of MLA is 250 μm. Assuming that the incident laser beam has a circular cross section which is 2 mm in diameter (or 1 mm radius). From this 1 MM, it is possible to accommodate about 4 lenses (pitch is 250 μm). Therefore, the total number of lenses which can be packed to receive a laser cross section diameter of 2 mm is about π×4², or 50. In other words, there are about 50 micro-lenses being illuminated. The incident power to a single lens is 10 mW while the total input power to MLA is 500 mW for the same illuminated intensity of each focusing spot. Raman signal of a malachite green (MG) sample on a surface enhance Raman scattering (SERS) substrate is measured by a traditional Raman setup and the setup of FIG. 3 for comparison.

FIG. 4 is a graph 400 comparing a first Raman spectra 402 measured by the MLA setup of FIG. 3 and a second Raman spectra 404 measured by a traditional single lens setup. An incident power of 10 mW was used in the traditional single lens setup while an incident power of 500 mW was used such that the same input power of 10 mW was used for each lens in the MLA. In FIG. 4, signal intensity of the first Raman spectra 402 is read from the left vertical axis while signal intensity of the second Raman spectra 404 is read from the right vertical axis. Results show that by controlling substantially the same intensity of each focused spot on the sample surface, the SNR of the first Raman signal 402 measured by the MLA setup is significantly higher (about 16 times higher) than that measured by the second Raman signal 404 measured by the traditional single lens setup.

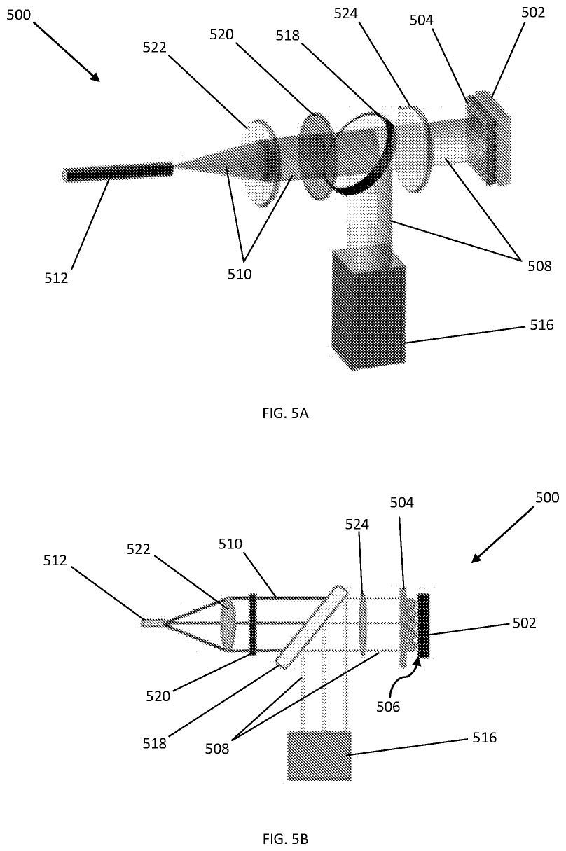

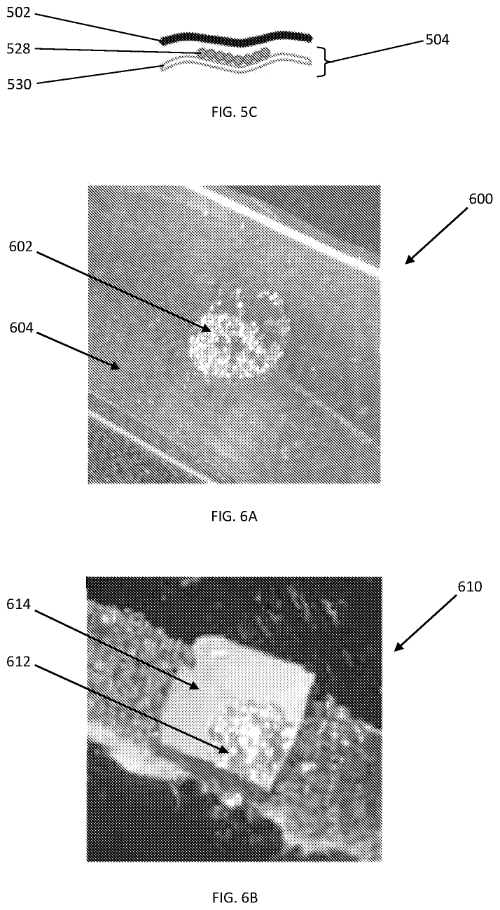

FIG. 5A is a perspective view drawing of a system 500 for performing spectroscopic analysis of a sample 502 in an example embodiment. FIG. 5B is a side view drawing of the system 500 in the example embodiment.

The system 500 comprises an array of lenses e.g. MLA 504 (compare 104 of FIG. 1) positioned adjacent to a surface 506 of the sample 502 such that a first incident electromagnetic radiation 508 for irradiating the surface 506 of the sample 502 passes through the array of lenses 504 before irradiating the surface 506 of the sample 502. The array of lenses 504 is further configured to direct the first incident electromagnetic radiation 508 passing therethrough to form a plurality of incident electromagnetic radiation e.g. multiple focal/focused spots (not shown, compare 114 of FIG. 1) on the surface 506 of the sample 502.

The MLA 504 is further configured to direct a second scattered electromagnetic radiation 510 from the sample 502 to a detector unit e.g. through fibre 512 of a spectrometer. The second scattered electromagnetic radiation 510 comprises electromagnetic waves that are scattered, emitted and/or reflected by the sample 502. The scattered, emitted and/or reflected electromagnetic waves may comprise Raman signals having a higher or lower frequency as compared to the frequency of the incident electromagnetic radiation. The MLA 504 is further configured to collimate the second scattered electromagnetic radiation.

The system 500 further comprises an electromagnetic wave emitter e.g. laser source 516 (compare 216 of FIG. 2) for emitting the first incident electromagnetic radiation 508. The system 500 further comprises a splitter e.g. beam splitter 518 (compare 218 of FIG. 2) positioned to receive the incident electromagnetic radiation 508 from the laser source 516 and to reflect the first electromagnetic radiation 508 by 90 degrees from its original path towards the array of lenses 504. The beam splitter 518 is further configured to allow the second scattered electromagnetic radiation 510 to pass therethrough towards the detector unit 512 of the spectrometer. The system 500 further comprises a first focusing lens 524 positioned between the beam splitter 518 and the MLA 504, said first focusing lens 524 is configured to adjust the size e.g. laser spot size of the first incident electromagnetic radiation 508 on the MLA 504. The system 500 further comprises a filter e.g. band-stop notch filter 520 (compare 220 of FIG. 2) positioned between the beam splitter 518 and the through fibre 512 of a spectrometer to reject Rayleigh scattering signals in the second scattered electromagnetic radiation 510 and to allow Raman scattering signals in the second scattered electromagnetic radiation 510 to pass through. The system 500 further comprises a second focusing lens 522 (compare 222 of FIG. 2) positioned between the band-stop notch filter 520 and the through fibre 512 of a spectrometer to direct the second scattered electromagnetic radiation 510 into the detector unit 512 of the spectrometer.

The system 500 is substantially similar to the system 200 of FIG. 2 except for the array of lenses which is described below with reference to FIG. 5C.

FIG. 5C is a magnified view of the MLA 504 in the example embodiment. The MLA 504 comprises a plurality of lenses e.g. 528 disposed on a support layer 530. In the example embodiment, the MLA 504 is formed by an array of microspheres. A suspension of microspheres is dropped to a support layer e.g. substrate. Due to the self-assembly effect, the microspheres will be compactly rearranged as shown in FIG. 5C to form an array of microspheres. With illumination from the substrate side, the microspheres on the substrate are capable of generating multiple focal spots such that each of the microsphere functions as a lens which is capable directing the electromagnetic radiation passing therethrough to form a plurality of incident electromagnetic radiation, each of the plurality of incident electromagnetic radiation irradiating a different focussed spot on the surface of the sample. It will be appreciated that the substrate is not limited by silica wafers and can be replaced by transparent polymer substrates.

In the example embodiment, the support layer 530 is a substantially flexible layer. Therefore, the MLA 504 on the polymer is substantially flexible and is capable of substantially conforming to the surface 506 of the sample 502. If the target sample for Raman spectrum detection is curved, the MLA 504 is capable of being directly attached e.g. pasted on the sample. Advantageously, such a configuration allows the system to be compatible with other Raman enhancement techniques, such as surface enhanced Raman scattering (SERS). In addition, as the MLA 504 is capable of substantially conforming to a sample surface, the target sample for spectroscopic analysis is not limited to any particular type of surface.

In operation, excitation light from the laser source 516 is collimated and illuminated on the beam splitter 518 which reflects the excitation light towards the sample 502. The reflected excitation light is focused by the MLA 504 on the surface 506 of the sample 502. Multiple focusing spots are generated at the focal plane, which is focused at substantially the same surface 506 of the sample 502 to be detected. Back-scattered or reflected light comprising Raman signals are generated at multiple focusing spots when the incident excitation light interacts with the sample. Thereafter, the back-scattered or reflected light comprising the Raman signal from each spot is collimated by the MLA 504. The collimated Raman signal is separated from the excitation light by the band-stop notch filter 520. Thereafter, the focusing lens 522 couples or directs the filtered light comprising the Raman signal into a fiber 512 which connects to the spectrometer or directly illuminates on the input slit of the spectrometer for spectroscopic analysis.

FIG. 6A is a photograph 600 showing microspheres 602 distributed on a poly(ε-caprolactone) (PCL) film 604 in an example embodiment. FIG. 6B is a photograph 610 showing microspheres 612 distributed on a SERS (surface-enhanced Raman scattering) substrate 614 in an example embodiment. To achieve the same enhancement effect, the microspheres can be directly distributed onto a sample as shown in FIG. 6B. The sample in FIG. 6B is a SERS substrate with pre-dropped target material (1 μM malachite green).

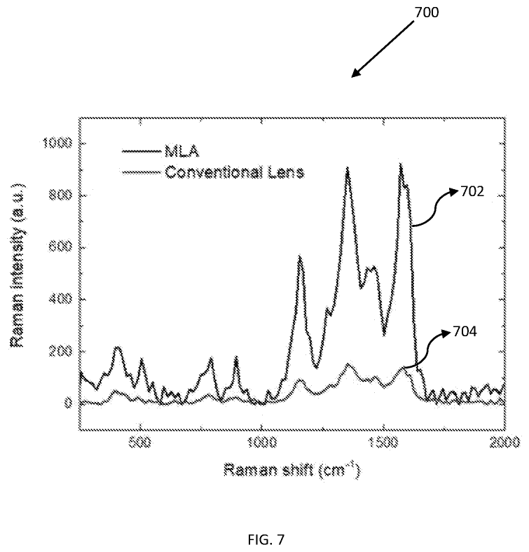

FIG. 7 is a graph 700 comparing a first Raman spectra 702 detected by the MLA setup of FIG. 5 and a second Raman spectra 704 detected by a conventional lens setup. The first Raman spectra 702 was performed on the substrate in FIG. 6B at the area covered with microspheres and the second Raman spectra 704 was performed on the substrate in FIG. 6B at the naked area not covered with microspheres. Integration time and laser power of measurement were fixed at 1 second and 25 mW respectively. The results indicate about 6 times Raman signal enhancement after adding microspheres.

In view of the above, it will be appreciated that by using this type of MLA in example embodiments, the Raman signal can be enhanced. Further, it will be appreciated that compared with existing commercialized MLA, the MLA formed by self-assembly microspheres are more cost effective and more convenient in application.

It will also be appreciated that because the working distance of the microsphere lens is relatively short (i.e., the focal point of the microsphere is relatively short), the MLA can be positioned to be in direct contact with the sample. This can advantageously alleviate any issues arising from maintaining a set parallel distance between the microsphere lens and the sample to achieve good focus for each of the incident electromagnetic radiation on a different spot on the sample.

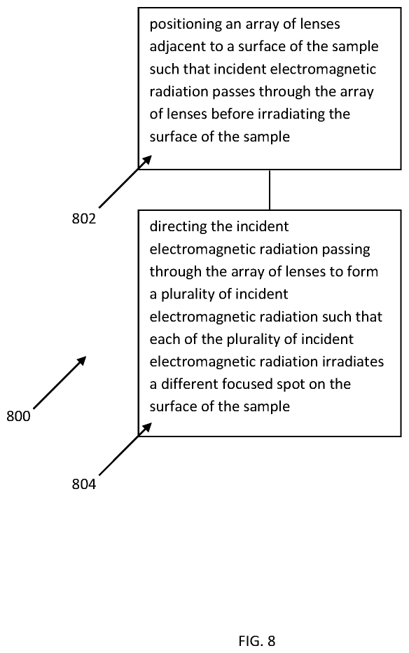

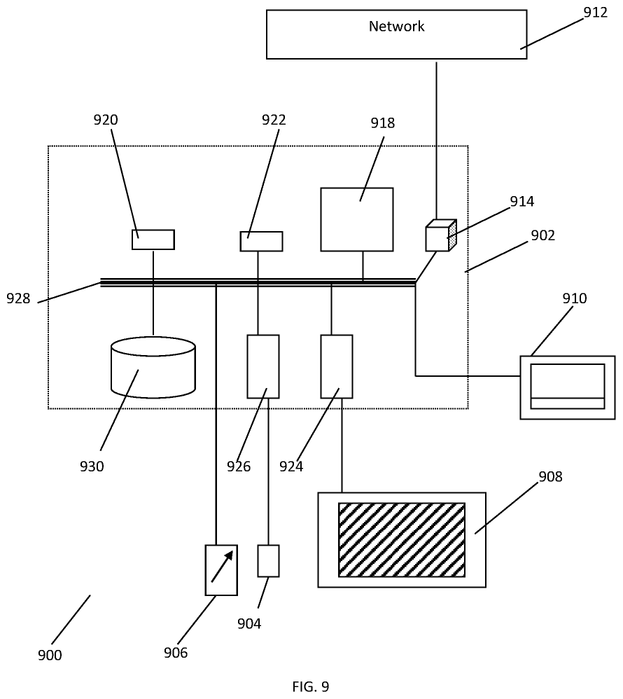

FIG. 8 is a schematic flowchart 800 for illustrating a method of performing spectroscopic analysis of a sample in an example embodiment. At step 802, an array of lenses is positioned adjacent to a surface of the sample such that incident electromagnetic radiation passes through the array of lenses before irradiating the surface of the sample. At step 804, the incident electromagnetic radiation passing through the array of lenses is directed to form a plurality of incident electromagnetic radiation such that each of the plurality of incident electromagnetic radiation irradiates a different focused spot on the surface of the sample.

In the described example embodiments, a system and a method for performing spectroscopic analysis on a sample are provided. The system comprises an array of lenses e.g. a micro-lens array (MLA) capable of exciting multiple spots at a sample surface for Raman signal generation and collecting the Raman signal. Compared with traditional Raman spectroscope, the described example embodiments are capable of generating a plurality of focusing spots, instead of just one spot. This can advantageously increase the total intensity of Raman signal significantly at the same illuminated laser intensity. For samples with weak Raman responses, the Raman peaks can be detected by increasing the input power. However, it is limited by the damage threshold of the sample. In the described example embodiments of the system, the intensity of the Raman signal can be magnified by n times, where n is the number of the micro-lenses covered by the excitation laser beam. This advantageously increases signal to noise ratio (SNR) for weak Raman signal detection and at the same time decreases the possibility of damaging the sample in Raman spectrum measurement.

In addition, described example embodiments of the system and method are employed to increase total Raman signal intensity for analyzing materials. As such, there is no need for complex microscopic imaging systems for increasing the scanning or imaging speed of e.g. coherent anti-stokes Raman imaging, confocal Raman imaging etc. Described example embodiments of the system and method are compatible with other Raman enhancement techniques, such as surface enhanced Raman scattering (SERS) and may also extend the Raman applications for low excitation laser intensity requirement. In addition, example embodiments of the system and method may advantageously be applied in portable Raman spectrometer design to provide a portable device based on Raman spectrum measurement at higher signal to noise ratio.

The terms “coupled” or “connected” as used in this description are intended to cover both directly connected or connected through one or more intermediate means, unless otherwise stated.

The description herein may be, in certain portions, explicitly or implicitly described as algorithms and/or functional operations that operate on data within a computer memory or an electronic circuit. These algorithmic descriptions and/or functional operations are usually used by those skilled in the information/data processing arts for efficient description. An algorithm is generally relating to a self-consistent sequence of steps leading to a desired result. The algorithmic steps can include physical manipulations of physical quantities, such as electrical, magnetic or optical signals capable of being stored, transmitted, transferred, combined, compared, and otherwise manipulated.

Further, unless specifically stated otherwise, and would ordinarily be apparent from the following, a person skilled in the art will appreciate that throughout the present specification, discussions utilizing terms such as “scanning”, “calculating”, “determining”, “replacing”, “generating”, “initializing”, “outputting”, and the like, refer to action and processes of an instructing processor/computer system, or similar electronic circuit/device/component, that manipulates/processes and transforms data represented as physical quantities within the described system into other data similarly represented as physical quantities within the system or other information storage, transmission or display devices etc.

The description also discloses relevant device/apparatus for performing the steps of the described methods. Such apparatus may be specifically constructed for the purposes of the methods, or may comprise a general purpose computer/processor or other device selectively activated or reconfigured by a computer program stored in a storage member. The algorithms and displays described herein are not inherently related to any particular computer or other apparatus. It is understood that general purpose devices/machines may be used in accordance with the teachings herein. Alternatively, the construction of a specialized device/apparatus to perform the method steps may be desired.

In addition, it is submitted that the description also implicitly covers a computer program, in that it would be clear that the steps of the methods described herein may be put into effect by computer code. It will be appreciated that a large variety of programming languages and coding can be used to implement the teachings of the description herein. Moreover, the computer program if applicable is not limited to any particular control flow and can use different control flows without departing from the scope of the invention.

Furthermore, one or more of the steps of the computer program if applicable may be performed in parallel and/or sequentially. Such a computer program if applicable may be stored on any computer readable medium. The computer readable medium may include storage devices such as magnetic or optical disks, memory chips, or other storage devices suitable for interfacing with a suitable reader/general purpose computer. In such instances, the computer readable storage medium is non-transitory. Such storage medium also covers all computer-readable media e.g. medium that stores data only for short periods of time and/or only in the presence of power, such as register memory, processor cache and Random Access Memory (RAM) and the like. The computer readable medium may even include a wired medium such as exemplified in the Internet system, or wireless medium such as exemplified in bluetooth technology. The computer program when loaded and executed on a suitable reader effectively results in an apparatus that can implement the steps of the described methods.

The example embodiments may also be implemented as hardware modules. A module is a functional hardware unit designed for use with other components or modules. For example, a module may be implemented using digital or discrete electronic components, or it can form a portion of an entire electronic circuit such as an Application Specific Integrated Circuit (ASIC). A person skilled in the art will understand that the example embodiments can also be implemented as a combination of hardware and software modules.

Additionally, when describing some embodiments, the disclosure may have disclosed a method and/or process as a particular sequence of steps. However, unless otherwise required, it will be appreciated the method or process should not be limited to the particular sequence of steps disclosed. Other sequences of steps may be possible. The particular order of the steps disclosed herein should not be construed as undue limitations. Unless otherwise required, a method and/or process disclosed herein should not be limited to the steps being carried out in the order written. The sequence of steps may be varied and still remain within the scope of the disclosure.

Further, in the description herein, the word “substantially” whenever used is understood to include, but not restricted to, “entirely” or “completely” and the like. In addition, terms such as “comprising”, “comprise”, and the like whenever used, are intended to be non-restricting descriptive language in that they broadly include elements/components recited after such terms, in addition to other components not explicitly recited. For an example, when “comprising” is used, reference to a “one” feature is also intended to be a reference to “at least one” of that feature. Terms such as “consisting”, “consist”, and the like, may, in the appropriate context, be considered as a subset of terms such as “comprising”, “comprise”, and the like. Therefore, in embodiments disclosed herein using the terms such as “comprising”, “comprise”, and the like, it will be appreciated that these embodiments provide teaching for corresponding embodiments using terms such as “consisting”, “consist”, and the like. Further, terms such as “about”, “approximately” and the like whenever used, typically means a reasonable variation, for example a variation of +/−5% of the disclosed value, or a variance of 4% of the disclosed value, or a variance of 3% of the disclosed value, a variance of 2% of the disclosed value or a variance of 1% of the disclosed value.

Furthermore, in the description herein, certain values may be disclosed in a range. The values showing the end points of a range are intended to illustrate a preferred range. Whenever a range has been described, it is intended that the range covers and teaches all possible sub-ranges as well as individual numerical values within that range. That is, the end points of a range should not be interpreted as inflexible limitations. For example, a description of a range of 1% to 5% is intended to have specifically disclosed sub-ranges 1% to 2%, 1% to 3%, 1% to 4%, 2% to 3% etc., as well as individually, values within that range such as 1%, 2%, 3%, 4% and 5%. The intention of the above specific disclosure is applicable to any depth/breadth of a range.

Different example embodiments can be implemented in the context of data structure, program modules, program and computer instructions executed in a computer implemented environment. A specially configured general purpose computing environment is briefly disclosed herein. One or more example embodiments may be embodied in one or more computer systems, such as is schematically illustrated in FIG. 9.

One or more example embodiments may be implemented as software, such as a computer program being executed within a computer system 900, and instructing the computer system 900 to conduct a method of an example embodiment.

The computer system 900 comprises a computer unit 902, input modules such as a keyboard 904 and a pointing device 906 and a plurality of output devices such as a display 908, and printer 910. A user can interact with the computer unit 902 using the above devices. The pointing device can be implemented with a mouse, track ball, pen device or any similar device. One or more other input devices (not shown) such as a joystick, game pad, satellite dish, scanner, touch sensitive screen or the like can also be connected to the computer unit 902. The display 908 may include a cathode ray tube (CRT), liquid crystal display (LCD), field emission display (FED), plasma display or any other device that produces an image that is viewable by the user.

The computer unit 902 can be connected to a computer network 912 via a suitable transceiver device 914, to enable access to e.g. the Internet or other network systems such as Local Area Network (LAN) or Wide Area Network (WAN) or a personal network. The network 912 can comprise a server, a router, a network personal computer, a peer device or other common network node, a wireless telephone or wireless personal digital assistant. Networking environments may be found in offices, enterprise-wide computer networks and home computer systems etc. The transceiver device 914 can be a modem/router unit located within or external to the computer unit 902, and may be any type of modem/router such as a cable modem or a satellite modem.

It will be appreciated that network connections shown are exemplary and other ways of establishing a communications link between computers can be used. The existence of any of various protocols, such as TCP/IP, Frame Relay, Ethernet, FTP, HTTP and the like, is presumed, and the computer unit 902 can be operated in a client-server configuration to permit a user to retrieve web pages from a web-based server. Furthermore, any of various web browsers can be used to display and manipulate data on web pages.

The computer unit 902 in the example comprises a processor 918, a Random Access Memory (RAM) 920 and a Read Only Memory (ROM) 922. The ROM 922 can be a system memory storing basic input/output system (BIOS) information. The RAM 920 can store one or more program modules such as operating systems, application programs and program data.

The computer unit 902 further comprises a number of Input/Output (I/O) interface units, for example I/O interface unit 924 to the display 908, and I/O interface unit 926 to the keyboard 904. The components of the computer unit 902 typically communicate and interface/couple connectedly via an interconnected system bus 928 and in a manner known to the person skilled in the relevant art. The bus 928 can be any of several types of bus structures including a memory bus or memory controller, a peripheral bus, and a local bus using any of a variety of bus architectures.

It will be appreciated that other devices can also be connected to the system bus 928. For example, a universal serial bus (USB) interface can be used for coupling a video or digital camera to the system bus 928. An IEEE 1394 interface may be used to couple additional devices to the computer unit 902. Other manufacturer interfaces are also possible such as FireWire developed by Apple Computer and i.Link developed by Sony. Coupling of devices to the system bus 928 can also be via a parallel port, a game port, a PCI board or any other interface used to couple an input device to a computer. It will also be appreciated that, while the components are not shown in the figure, sound/audio can be recorded and reproduced with a microphone and a speaker. A sound card may be used to couple a microphone and a speaker to the system bus 928. It will be appreciated that several peripheral devices can be coupled to the system bus 928 via alternative interfaces simultaneously.

An application program can be supplied to the user of the computer system 900 being encoded/stored on a data storage medium such as a CD-ROM or flash memory carrier. The application program can be read using a corresponding data storage medium drive of a data storage device 930. The data storage medium is not limited to being portable and can include instances of being embedded in the computer unit 902. The data storage device 930 can comprise a hard disk interface unit and/or a removable memory interface unit (both not shown in detail) respectively coupling a hard disk drive and/or a removable memory drive to the system bus 928. This can enable reading/writing of data. Examples of removable memory drives include magnetic disk drives and optical disk drives. The drives and their associated computer-readable media, such as a floppy disk provide nonvolatile storage of computer readable instructions, data structures, program modules and other data for the computer unit 902. It will be appreciated that the computer unit 902 may include several of such drives. Furthermore, the computer unit 902 may include drives for interfacing with other types of computer readable media.

The application program is read and controlled in its execution by the processor 918. Intermediate storage of program data may be accomplished using RAM 920. The method(s) of the example embodiments can be implemented as computer readable instructions, computer executable components, or software modules. One or more software modules may alternatively be used. These can include an executable program, a data link library, a configuration file, a database, a graphical image, a binary data file, a text data file, an object file, a source code file, or the like. When one or more computer processors execute one or more of the software modules, the software modules interact to cause one or more computer systems to perform according to the teachings herein.

The operation of the computer unit 902 can be controlled by a variety of different program modules. Examples of program modules are routines, programs, objects, components, data structures, libraries, etc. that perform particular tasks or implement particular abstract data types. The example embodiments may also be practiced with other computer system configurations, including handheld devices, multiprocessor systems, microprocessor-based or programmable consumer electronics, network PCs, minicomputers, mainframe computers, personal digital assistants, mobile telephones and the like. Furthermore, the example embodiments may also be practiced in distributed computing environments where tasks are performed by remote processing devices that are linked through a wireless or wired communications network. In a distributed computing environment, program modules may be located in both local and remote memory storage devices.

In the described example embodiments, the micro-lens array is an array of lenses e.g. micro-sized lenslets having substantially the same shape. It would be appreciated that the array of lenses may be arranged in a regular pattern or without a regular pattern. For example, the array of lenses may be arranged in a square array, hexagonal arrangement, random arrangement and the like. For example, an array of lenses formed via self-assembly effect of microspheres may have a random arrangement which is not a regular pattern.

In the described example embodiments, the shape of the lens in the array of lenses may be cylindrical, non-cylindrical, spherical, aspherical, circular, square, rectangular, hexagonal or other user-specified shapes.

In the described example embodiments, the size of each lens in the array of lenses may range from about 1 μm to about 5000 μm.

In the described example embodiments, the material of the lens in the array of lenses is substantially transparent and may include but is not limited to plastic, glass, quartz, tantalum, zinc selenide (ZnSe), silicon, calcium fluoride or poly(methyl methacrylate) (PMMA).

In the described example embodiments, although it is described that the same array of lenses is used to direct incident electromagnetic radiation passing therethrough to the surface of the sample and to direct scattered electromagnetic radiation from the sample to the spectrometer, the example embodiments are not limited as such. It would be appreciated that more than one array of lenses may be used in the system and method for performing spectroscopic analysis of a sample. For example, a first array of lenses may be provided to direct incident electromagnetic radiation passing therethrough to a surface of the sample, a second or additional array of lenses may be provided to direct scattered electromagnetic radiation from the sample to the spectrometer.

It will be appreciated by a person skilled in the art that other variations and/or modifications may be made to the specific embodiments without departing from the scope of the invention as broadly described. For example, in the description herein, features of different example embodiments may be mixed, combined, interchanged, incorporated, adopted, modified, included etc. or the like across different example embodiments. The present embodiments are, therefore, to be considered in all respects to be illustrative and not restrictive.

1. A system for performing spectroscopic analysis of a sample, the system comprising,
an array of lenses positioned adjacent to a surface of the sample such that incident electromagnetic radiation passes through the array of lenses before irradiating the surface of the sample,
and wherein the array of lenses is further configured to direct the incident electromagnetic radiation passing therethrough to form a plurality of incident electromagnetic radiation, each of the plurality of incident electromagnetic radiation irradiating a different focused spot on the surface of the sample.

2. The system of claim 1, wherein the array of lenses comprises a plurality of lenses disposed on a support layer, and
wherein the support layer is a substantially rigid layer, or a substantially flexible layer that is configured to substantially conform to the surface of the sample.

3. The system of claim 1, wherein the array of lenses is configured to contact the surface of the sample; or is configured to be positioned no more than 1000 μm from the surface of the sample.

4. The system of claim 1, wherein the array of lenses comprises a focal plane such that the surface of the sample is arranged to be substantially parallel to the focal plane.

5. The system of claim 1, further comprising a monochromatic electromagnetic wave emitter configured to emit the incident electromagnetic radiation, wherein the incident electromagnetic radiation has a frequency selected from the ultraviolet, visible, or infrared spectrum.

6. The system of claim 5, wherein the array of lenses is further configured to direct a scattered electromagnetic radiation from the sample to a detector unit of a spectrometer, said scattered electromagnetic radiation comprising radiation reflected or scattered from the sample.

7. The system of claim 6, wherein the scattered electromagnetic radiation comprises Raman signals, said Raman signals having a higher or lower frequency as compared to the frequency of the incident electromagnetic radiation.

8. The system of claim 7, further comprising an optical assembly configured to direct the incident electromagnetic radiation from the emitter towards the array of lenses, the optical assembly further configured to direct the scattered electromagnetic radiation from the array of lenses to the detector unit of the spectrometer.

9. The system of claim 8, wherein the optical assembly comprises,
a splitter configured to receive and reflect the incident electromagnetic radiation from the emitter towards the array of lenses, said splitter further configured to reflect the scattered electromagnetic radiation from the array of lenses to the detector unit of the spectrometer;
a filter configured to reject electromagnetic waves from the scattered electromagnetic radiation that has substantially the same frequency as the incident electromagnetic radiation; and
a focusing lens configured to direct the scattered electromagnetic radiation to the detector unit of the spectrometer.

10. A method of performing spectroscopic analysis of a sample, the method comprising,
positioning an array of lenses adjacent to a surface of the sample such that incident electromagnetic radiation passes through the array of lenses before irradiating the surface of the sample,
directing the incident electromagnetic radiation passing through the array of lenses to form a plurality of incident electromagnetic radiation such that each of the plurality of incident electromagnetic radiation irradiates a different focused spot on the surface of the sample.

11. The method of claim 10, wherein the array of lenses comprises a plurality of lenses disposed on a support layer, and
wherein the support layer is a substantially rigid layer, or a substantially flexible layer configured to substantially conform to the surface of the sample.

12. The method of claim 10, wherein positioning the array of lenses adjacent to the surface of the sample comprises contacting the array of lenses to the surface of the sample, or positioning the array of lenses at no more than 1000 μm from the surface of the sample.

13. The method of claim 10, further comprising positioning the array of lenses such that the surface of the sample is substantially parallel to a focal plane of the array of lenses.

14. The method of claim 10, further comprising emitting the incident electromagnetic radiation from a monochromatic electromagnetic wave emitter, wherein the incident electromagnetic radiation has a frequency selected from the ultraviolet, visible, or infrared spectrum.

15. The method of claim 14, further comprising directing a scattered electromagnetic radiation passing through the array of lenses to a detector unit of a spectrometer, wherein the scattered electromagnetic radiation comprises radiation reflected or scattered from the sample.

16. The method of claim 15, wherein the scattered electromagnetic radiation comprises Raman signals having a higher or lower frequency as compared to the frequency of the incident electromagnetic radiation.

17. The method of claim 16, further comprising providing an optical assembly to direct the incident electromagnetic radiation from the emitter towards the array of lenses, and to direct the scattered electromagnetic radiation from the array of lenses to the detector unit of the spectrometer.

18. The method of claim 17, further comprising,
receiving and reflecting the incident electromagnetic radiation from the emitter towards the array of lenses;
reflecting the scattered electromagnetic wave radiation from the array of lenses to the detector unit;
filtering the scattered electromagnetic wave radiation to reject electromagnetic waves from the scattered electromagnetic wave radiation that has substantially the same wavelength as the incident electromagnetic wave radiation; and
focusing the filtered scattered electromagnetic radiation into the detector unit of the spectrometer.

19. An attachment for a system for performing spectroscopic analysis of a sample, the attachment comprising,
an array of lenses configured to be positioned adjacent to a surface of the sample such that incident electromagnetic radiation for irradiating the surface of the sample passes through the array of lenses before irradiating the surface of the sample, and
wherein the array of lenses is further configured to direct the incident electromagnetic radiation passing therethrough to form a plurality of incident electromagnetic radiation, each of the plurality of incident electromagnetic radiation irradiating a difference focused spot on the surface of the sample.

20. The attachment of claim 19,
wherein the array of lenses comprises a plurality of lenses disposed on a support layer, and
wherein the support layer is a substantially rigid layer, or a substantially flexible layer that is configured to substantially conform to a surface of the sample.
